(19) United States
(12) Patent Application Publication
(10) Pub. No.: US 2003/0169412 A1
(43) Pub. Date: Sep. 11, 2003

(54) REACTION FRAME FOR A WAFER SCANNING STAGE WITH ELECTROMAGNETIC CONNECTIONS TO GROUND

(76) Inventor: Andrew J. Hazelton, San Carlos, CA (US)

Correspondence Address: RITTER, LANG & KAPLAN, 12930 SARATOGA AE. SUITE D1, SARATOGA, CA, 95070, US

(21) Appl. No.: 10/094,532

(22) Filed: Mar. 8, 2002

(51) Int. Cl. G03B 27/58

(52) U.S. Cl. 355/72; 355/76; 355/53; 318/649; 310/10; 310/12; 378/34

(57) ABSTRACT

Methods and apparatus for isolating vibrations associated induced by reaction forces and ground vibration are disclosed. According to one aspect of the present invention, a scanning stage apparatus includes a stage base, a stage, a driver, and a reaction frame. The stage moves over the stage base in a first translational direction, a second translational direction, and a first rotational direction. The driver causes the stage to move, and also causes at least one reaction force to be created when the stage moves. The reaction frame at least partially supports the driver, and along with the driver, is substantially decoupled from the stage base. The reaction force is arranged to be transmitted to the reaction frame. The electromagnetic coupling electromagnetically couples the reaction frame to a ground, and provides a stiffness and a damping between the reaction frame and the ground.

### CROSS REFERENCE TO RELATED APPLICATION

The present application is related to U.S. patent application Ser. No. 09/932,410, entitled “Reaction Force Isolation Frame,” filed Aug. 17, 2001, which is incorporated herein by reference in its entirety.

### BACKGROUND OF THE INVENTION

1. Field of Invention

The present invention relates generally to semiconductor processing equipment. More particularly, the present invention relates to a scanning stage apparatus which includes electromagnetic connections to a grounding surface which are effective to isolate vibrations induced by reaction forces created by movement of a stage within the scanning stage apparatus, and vibrations associated with the grounding surface.

2. Description of the Related Art

For precision instruments such as photolithography machines which are used in semiconductor processing, factors which affect the performance, e.g., accuracy, of the precisions instruments generally must be dealt with and, insofar as possible, eliminated. When the performance of a precision instrument is adversely affected, as for example by reaction forces or by vibrations, products formed using the precision instrument may be improperly formed and, hence, defective. For instance, a photolithography machine which is subjected to vibratory motion may cause an image projected by the photolithography machine to move, and, as a result, be aligned incorrectly on a projection surface such as a semiconductor wafer surface.

Scanning stages such as wafer scanning stages and reticle scanning stages are often used in semiconductor fabrication processes, and may be included in various photolithography and exposure apparatuses. Wafer scanning stages are generally used to position a semiconductor wafer such that portions of the wafer may be exposed as appropriate for masking or etching. Reticle scanning stages are generally used to accurately position a reticle or reticles for exposure over the semiconductor wafer. Patterns are generally resident on a reticle, which effectively serves as a mask or a negative for a wafer. When a reticle is positioned over a wafer as desired, a beam of light or a relatively broad beam of electrons may be collimated through a reduction lens, and provided to the reticle on which a thin metal pattern is placed. Portions of a light beam, for example, may be absorbed by the reticle while other portions pass through the reticle and are focused onto the wafer.

A stage such as a wafer scanning stage or a reticle scanning stage is typically supported by a base structure such that the stage may move in a linear direction. Planar or linear motors may be used to facilitate the movement of wafer scanning stages and reticle scanning stages within a photolithography apparatus or an exposure apparatus. A motor which moves or drives a stage is often mounted between the stage and the base structure. When a motor causes a stage to move, forces are typically created between moving and non-moving portions of the motor, and reaction forces are also generally created. That is, forces which accelerate the stage also act on the base structure substantially equally, and in the opposite direction. Such reaction forces may cause the base structure to move, and may also cause vibrations to be induced in the base structure. Movement of the base structure renders it more difficult to position the stage, as motion of the base structure causes the stage to move.

As will be appreciated by those skilled in the art, forces or vibrations generated within a photolithography apparatus or exposure apparatus may cause issues relating to photolithography and exposure operations. The accuracy associated with such operations may be compromised when forces and vibrations affect the positioning of wafers or reticles, for example.

Reaction frames are often used to isolate reaction forces of motors used to move stages by reducing the forces which may be transmitted to other portions of a photolithography apparatus or exposure apparatus by causing at least some of the reaction forces to be transmitted to ground through the reaction frame. For example, a reaction frame may be used to reduce the amount of reaction force which may be effectively transmitted by a motor which moves a stage to a base which supports the stage. However, reaction forces transmitted through a reaction frame may result in vibrations being induced within the reaction frame which, in turn, may adversely affect the performance of the photolithography apparatus or exposure apparatus. Additionally, ground vibrations which may be transmitted from the ground to the reaction frame may affect the stage.

In order to reduce the effect of reaction forces and vibrations on a reaction frame structure of a photolithography apparatus or an exposure apparatus, actuators may be added to a reaction frame or base to reduce the effect of reaction forces created by movement of a stage and vibrations induced by the reaction forces. FIG. 1a is a diagrammatic representation of a wafer stage apparatus which includes reaction force cancellation actuators. A portion of a stage apparatus 102 includes a reaction frame 106 which supports linear motors (not shown) that are generally coupled to a wafer scanning stage or table (not shown) which supports a wafer that is being scanned. Specifically, reaction frame 106 may support a magnet that cooperates with a corresponding coil of the linear motor to produce force. The linear motors allow movement of a wafer table along an x-axis 104a. Reaction forces generated by the movement of the linear motors along x-axis 104a may be substantially absorbed by reaction frame 106.

An air bearing 110 serves to allow reaction frame 106 to move with respect to a reaction frame base 114 which is supported on a base 118. Specifically, air bearing 110 allows reaction frame 106 to be substantially supported in space above reaction frame base 114. As a result, in-plane vibrations from a connection to ground 122 to base 118 may not be imparted on a wafer scanning stage (not shown).

Base 118 is generally arranged to support both reaction frame base 114 and a stage base (not shown), e.g., a base which supports a wafer scanning stage. In general, base 118 is coupled to connection to ground 122, either substantially directly or through the use of an active vibration isolation system (AVIS). For ease of illustration, components of stage apparatus 102, including, but not limited to, a wafer table and linear motors which enable a wafer table to scan, have not been shown.

When a scanning stage (not shown) moves, e.g., accelerates, along x-axis 104a using a linear motor (not shown) that is supported by reaction frame 106, a force is generally effectively applied between the moving portion of the linear motor and a stationary portion of the linear motor, which is coupled to reaction frame 106. As shown, a linear actuator 124 is coupled to connection to ground 122 to substantially cancel out the force generated when movement of a scanning stage (not shown) moves, e.g., along x-axis 104a. That is, linear actuator 124 is arranged to counteract vibrations and forces associated with the movement of the scanning stage (not shown) which cause reaction forces to be created along x-axis 104a.

Linear actuator 124 is arranged to apply forces along x-axis 104a, substantially independent of position and velocity in any direction. That is, linear actuator 124 has zero stiffness and damping, as described in U.S. Pat. No. 5,959,427, which is incorporated herein by reference in its entirety. Having zero stiffness and damping in linear actuator 124 generally enables relatively high frequency reaction forces to be transmitted substantially directly from reaction frame 106 to connection to ground 122 through linear actuator 124. The transmission of high frequency reaction forces is often considered to be undesirable, due to vibrations which may be induced in connection to ground 122 and subsequently transferred to other structures on the ground. Further, high frequency ground vibrations which affect reaction frame 106 may be transmitted to the linear motor supported within reaction frame 106 to a scanning stage (not shown), as well as other portions of stage apparatus 120, thereby affecting the overall performance of stage apparatus 120.

Therefore, what is needed is a method and an apparatus for isolating reaction forces while reducing the amount of vibrations which are transmitted through a reaction frame structure. That is, what is desired is a reaction frame structure which reduces reaction forces associated with the reaction frame structure, vibrations induced within the reaction frame structure by the reaction forces, and vibrations transmitted through the reaction frame structure from a ground surface.

### SUMMARY OF THE INVENTION

The present invention relates to reducing the coupling of vibrations to a reaction frame. According to one aspect of the present invention, a scanning stage apparatus includes a stage base, a stage, a driver, and a reaction frame. The stage moves over the stage base in a first translational direction, a second translational direction, and a first rotational direction. The driver causes the stage to move, and also causes at least one reaction force to be created when the stage moves. The reaction frame at least partially supports the driver, and along with the driver, is substantially decoupled from the stage base. The reaction force is arranged to be transmitted to the reaction frame. The electromagnetic coupling electromagnetically couples the reaction frame to a ground, and provides a stiffness and a damping between the reaction frame and the ground. In one embodiment, the electromagnetic coupling is either an electromagnetic actuator, a linear motor, an EI core motor, and a voice coil motor.

In another embodiment, the stiffness and the damping are automatically adjustable, and the apparatus also includes a sensor which determines a measurement associated with the reaction frame. The sensor is coupled to the electromagnetic coupling, and the measurement is arranged to be used to automatically adjust the stiffness and the damping.

An apparatus which reduces the coupling of ground vibrations to a reaction frame, and isolates vibrations induced by reaction forces, allows the apparatus to operate more accurately. When vibrations which may affect the operation of a stage associated with a photolithography or exposure process are either reduced or eliminated, the positioning of the stage may occur more accurately and more efficiently, e.g., adjustments to the position which are made to compensate for vibrations may be reduced or eliminated. An electromagnetic actuator with an adjustable stiffness and damping that is arranged to couple the reaction frame to a ground surface allows the effect of vibrations to be reduced.

According to another aspect of the present invention, a stage assembly includes a stage base as well as a stage that has three associated degrees of freedom and is arranged to slide with respect to the stage base. The assembly also includes a motor that causes the stage to slide with respect to at least one of the three associated degrees of freedom. When the motor causes the stage to slide with respect to the at least one of the three associated degrees of freedom, at least one reaction force is created with respect to the associated degree of freedom with respect to which the stage is sliding. A frame associated with the assembly supports at least a portion of the motor, and is substantially mechanically decoupled from the stage base to substantially prevent the reaction force from affecting the stage when the reaction force is imparted on the frame. Finally, the assembly includes an actuator that is coupled between the reaction frame and a ground surface. The actuator has a stiffness and a damping, and functions to reduce a transmission of vibrations through the reaction frame. In one embodiment, the stiffness and the damping are adjustable.

In accordance with yet another aspect of the present invention, a frame structure that is suitable for use in a scanning apparatus includes a body and an electromagnetic actuator. The body supports a driving mechanism that is arranged to drive a stage, and substantially absorbs a reaction force generated by the driving mechanism when the driving mechanism drives the stage. The electromagnetic actuator has an associated stiffness and a damping, and is coupled to the body. The electromagnetic actuator is also arranged to be coupled to a ground surface to reduce the affects of vibrations induced within the body.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1a is a diagrammatic representation of a wafer stage apparatus which includes reaction force cancellation actuators.

FIG. 1b is a diagrammatic representation of a stage apparatus which includes a shock absorber.

FIG. 2a is a diagrammatic representation of a stage apparatus which includes an electromagnetic coupling between a reaction frame and a ground surface in accordance with an embodiment of the present invention.

FIG. 2b is a diagrammatic representation of a stage apparatus, i.e., stage apparatus 202 of FIG. 2a, with a computing device which controls parameters associated with an electromagnetic coupling in accordance with an embodiment of the present invention.

FIG. 2c is a diagrammatic top-view representation of a portion of a stage apparatus, i.e., stage apparatus 202 of FIG. 2a, in accordance with an embodiment of the present invention.

FIG. 2d is a diagrammatic cross-sectional representation of a portion of a stage apparatus, i.e., stage apparatus 202′ of FIG. 2c, in accordance with an embodiment of the present invention.

FIG. 3 is a diagrammatic top-view representation of a portion of a scanning apparatus which includes multiple electromagnetic connections to ground in accordance with an embodiment of the present invention.

FIG. 4 is a diagrammatic block diagram representation of a control algorithm which may be used to control a displacement of one component of an electromagnetic coupling relative to another component in accordance with an embodiment of the present invention.

FIG. 5 is a diagrammatic representation of a photolithography apparatus which includes a reaction frame with an electromagnetic connection to ground in accordance with an embodiment of the present invention.

FIG. 6 is a process flow diagram which illustrates the steps associated with fabricating a semiconductor device in accordance with an embodiment of the present invention.

FIG. 7 is a process flow diagram which illustrates the steps associated with processing a wafer, i.e., step 1304 of FIG. 6, in accordance with an embodiment of the present invention.

### DETAILED DESCRIPTION OF THE EMBODIMENTS

Reducing reaction forces and vibrations within an apparatus such as a photolithography apparatus or an exposure apparatus is important to ensure that semiconductor fabrication processes may be implemented efficiently and accurately. To reduce reaction forces, reaction frames are often used to isolate reaction forces of motors used to move stages by transmitting at least some of the forces associated with moving the stages to ground. However, ground vibrations and vibrations induced by the reaction forces may be transmitted through the reaction frame into the overall apparatus, thereby compromising the performance of the overall apparatus, e.g., by affecting the accuracy with which stages may move.

By adding stiffness and damping to a connection between a reaction frame and ground, the amount of vibrations induced in the reaction frame by reaction forces may be substantially minimized. In addition, the coupling between ground vibrations and the reaction frame may also be substantially minimized. Hence, the amount of vibratory motion which may be transmitted into an overall apparatus through the reaction frame may be reduced.

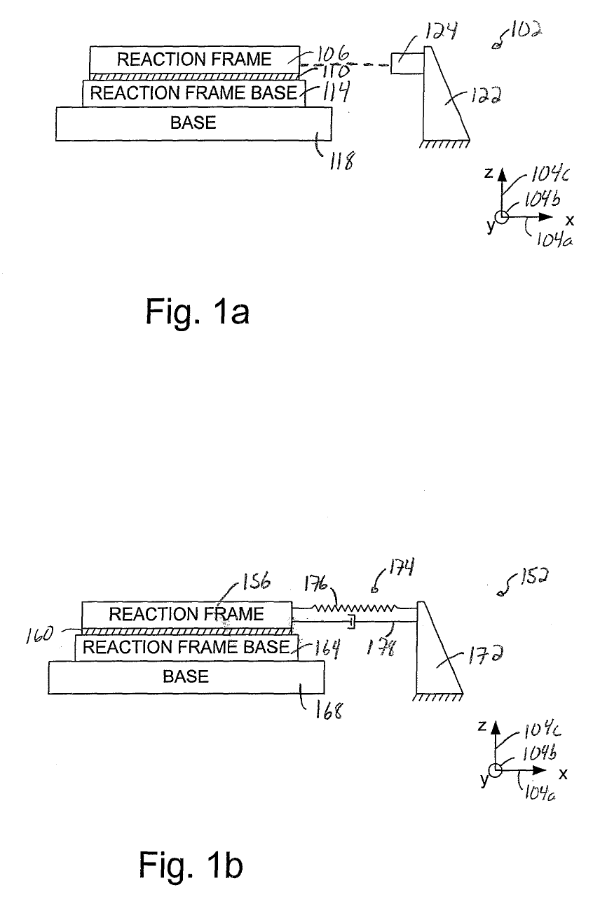

Stiffness and damping between a reaction frame and ground may be created by effectively positioning a “shock absorber” between the reaction frame and ground. With reference to FIG. 1b, a stage apparatus which includes a shock absorber will be described. A stage apparatus 152 is similar to stage apparatus 102 of FIG. 1a, and includes a reaction frame 156 which supports a linear motor (not shown) that allows a scanning stage (not shown) to move, an air bearing 160, a reaction frame base 164, and a base 168. Stage apparatus 152 is arranged to be substantially coupled to a ground. Specifically, reaction frame 156 is coupled to a connection to ground 172 through a shock absorber 174 such that reaction forces imparted on reaction frame 156 by connection to ground 172 may be substantially absorbed by shock absorber 174. Shock absorber 174 is generally arranged to provide stiffness and damping, and absorbs some of the reaction forces generated when magnet 156 accelerates. As shown, shock absorber 174 effectively includes a spring 176 and a damper 178, or a dashpot. That is, shock absorber 174 may be modeled as including spring 176 and damper 178. Shock absorber 174 may be coupled to, but is not necessarily coupled to, reaction frame 156 by a flexure (not shown). Since shock absorber 174 absorbs some reaction forces, the reaction forces which actually are transmitted through reaction frame 156 may be reduced. Undesirable vibrations from reaction forces associated with the movement of the scanning stage (not shown) may also be reduced and, hence, prevented from significantly affecting the performance of stage apparatus 152.

When a scanning stage accelerates along an x-axis 104a, reaction frame 156 may cause spring 176 to compress or extend. The amount by which spring 176 compresses or extends is dependent both upon the stiffness of spring 176 and the amount of damping provided by damper 178. The stiffness and damping provided by shock absorber 174 enables reaction forces to be substantially absorbed. It should be appreciated, however, that the use of shock absorber 174 may allow vibrations associated with connection to ground 172 to be transmitted to reaction frame 156 and, hence, affect the overall operation of scanning apparatus 152. When ground vibrations, particularly high frequency ground vibrations, are transmitted through shock absorber 174, the ground vibrations may affect the accuracy with which a scanning stage (not shown) may be positioned.

While shock absorber 174 is generally effective in reducing reaction forces coupled to ground, the stiffness ‘k’ associated with spring 176 and the damping coefficient ‘c’ associated with damper 178 must generally be adjusted such that the stiffness and the damping coefficient are suited for a particular environment. In other words, in order for shock absorber 174 to serve its purpose, the stiffness and the damping coefficient associated with shock absorber 174 must be selected depending upon the magnitudes of expected reaction forces and present in a given environment. As such, shock absorber 174 is either manually adjusted or replaced each time an environment changes. Manually adjusting or replacing shock absorber 174 in order to substantially manually “tune” shock absorber 174 may be a relatively inconvenient, inefficient, time-consuming, difficult process. When changes in the environment necessitate relatively frequent changes in the stiffness and the damping coefficient associated with shock absorber 174, the use of shock absorber 174 may be particularly time-consuming and inconvenient.

By providing electromagnetic connections between a reaction frame and a ground surface in lieu of shock absorbers, the coupling of ground vibrations to the reaction frame may be reduced. Hence, the transmission of vibrations through the reaction frame may be reduced. Vibrations induced within the reaction frame as a result of reaction forces may also be reduced. Reducing vibrations that may be transmitted through a reaction frame and reducing induced vibrations within the reaction frame enables an overall stage apparatus to operate more precisely, i.e., with less error and less need for error compensation.

In addition, when the electromagnetic connections are coupled to a computing device which controls parameters associated with the electromagnetic connections, stiffness parameters and damping parameters may be dynamically adjusted by the computing device to compensate for environmental changes. That is, the amount of stiffness and damping provided by the electromagnetic connections may be adaptively adjusted by the computing device. As such, compensating for environmental changes such as increased ground vibrations may occur relatively efficiently.

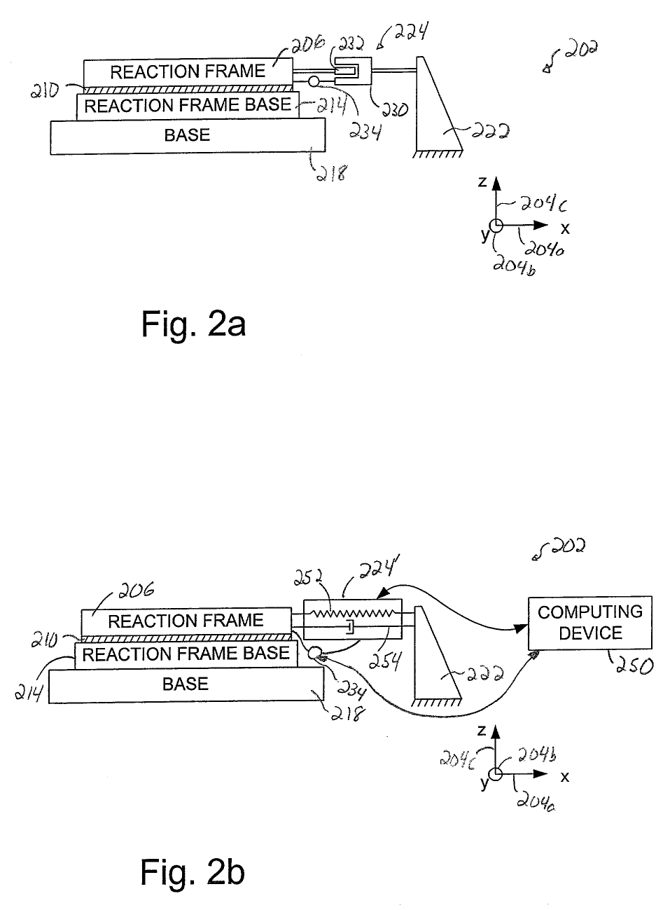

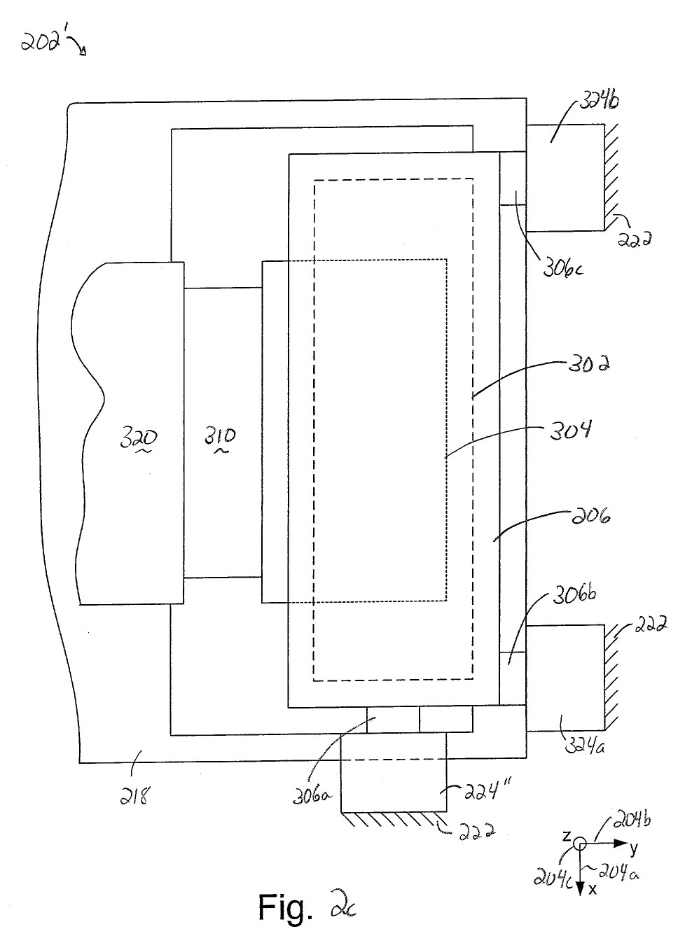

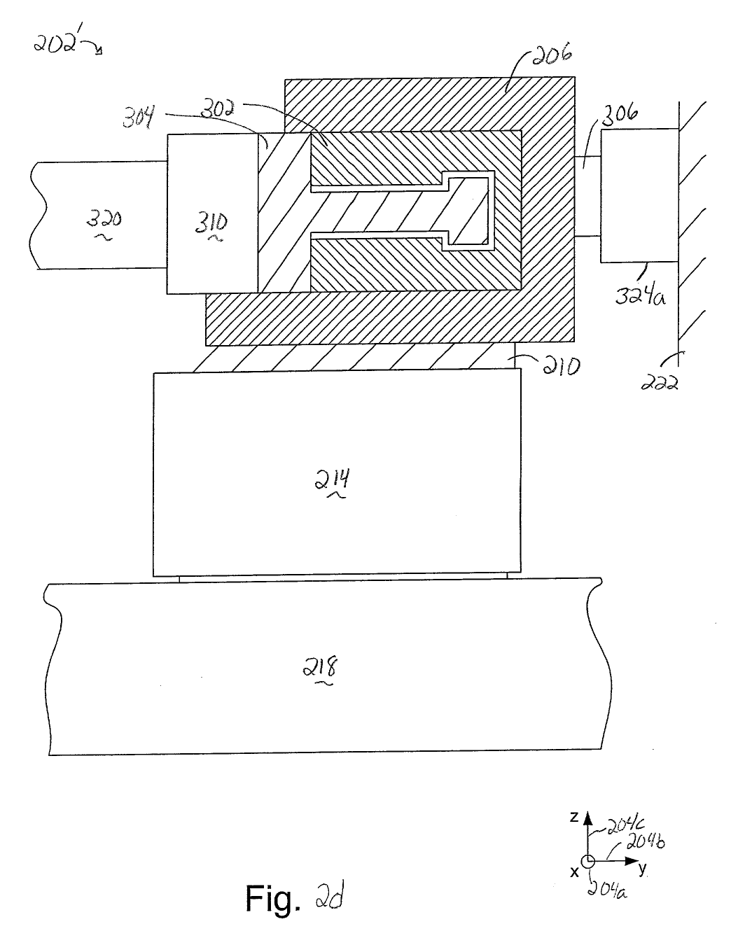

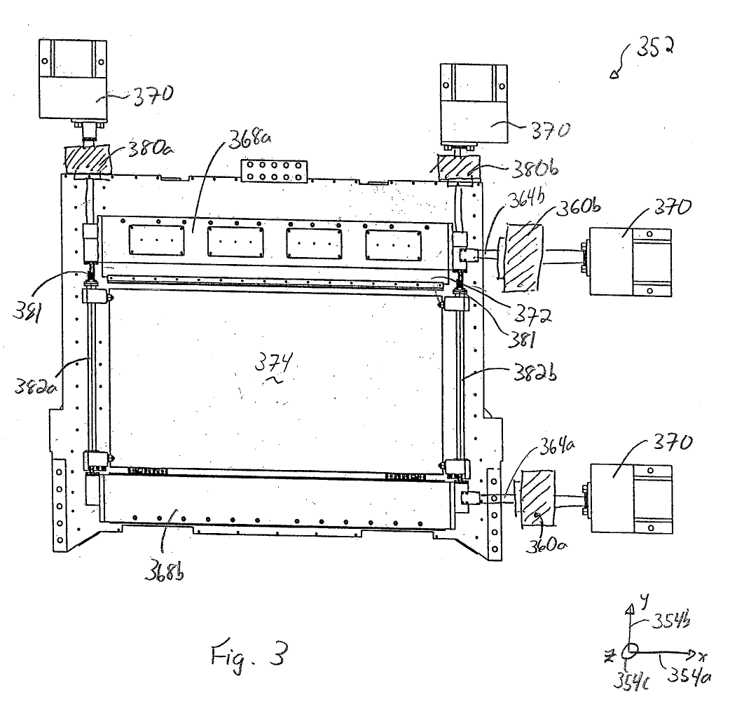

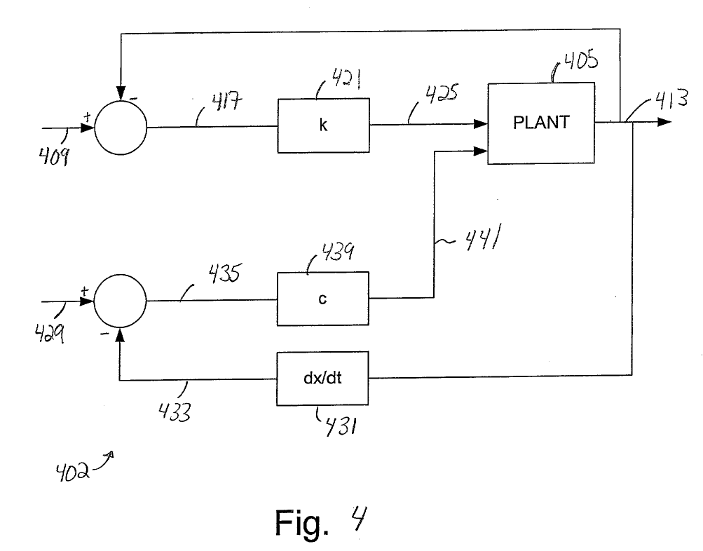

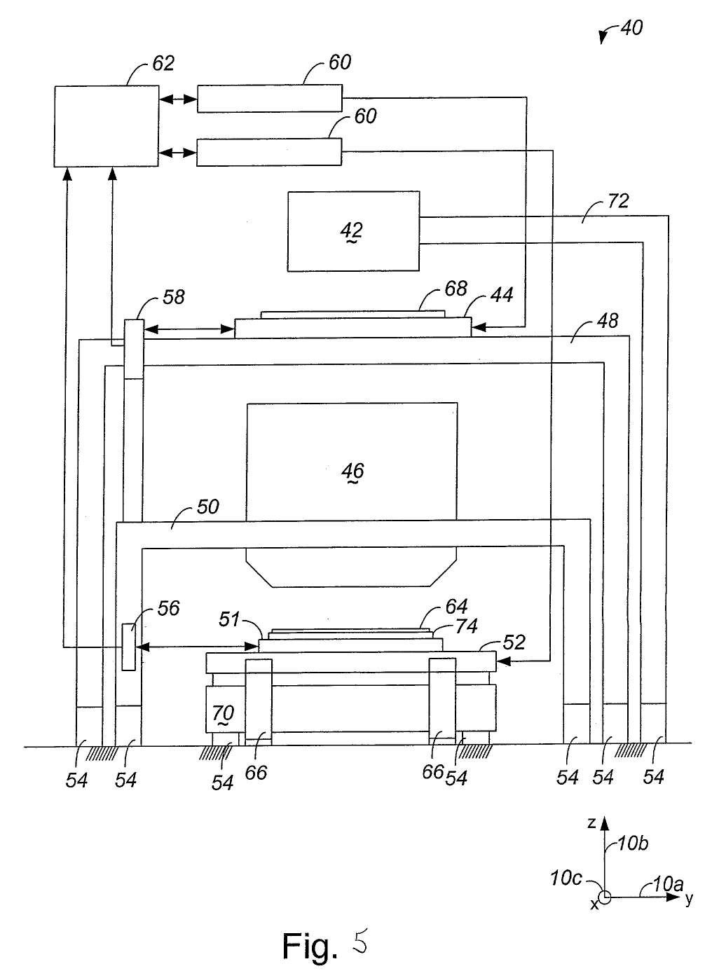

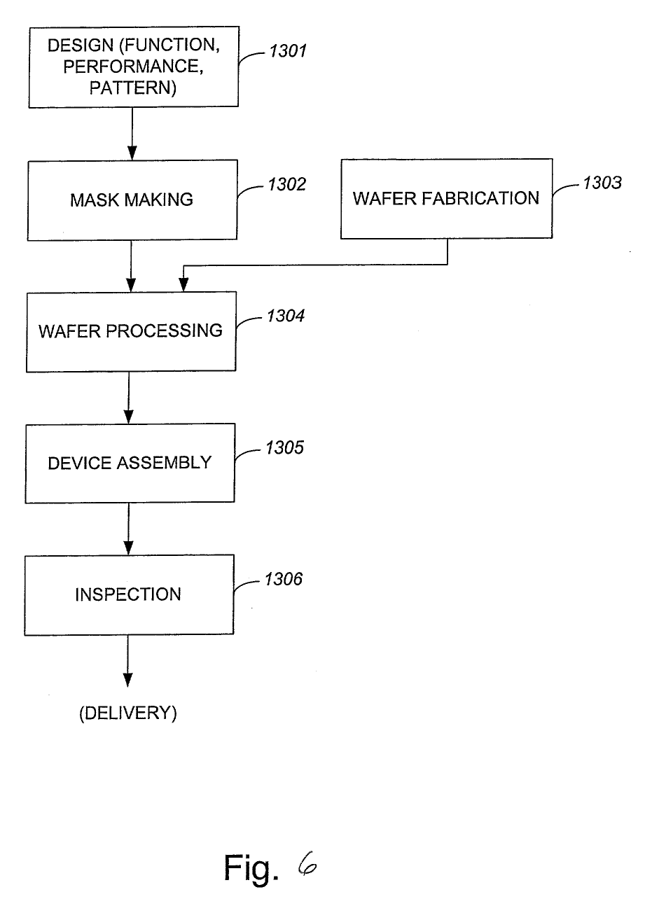

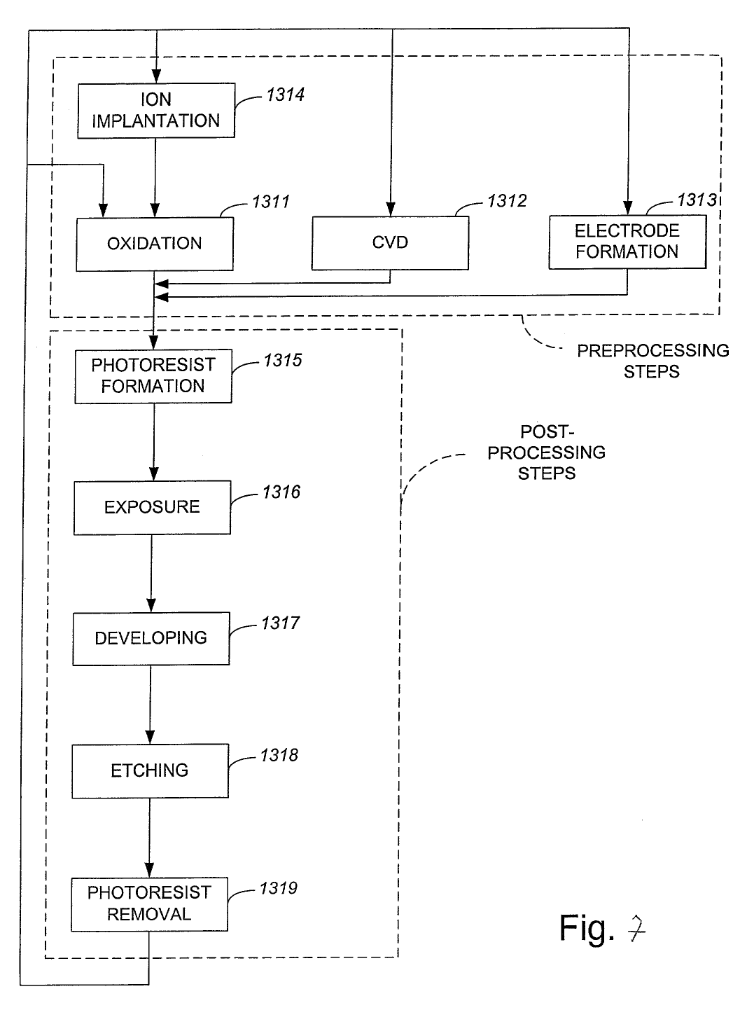

With reference to FIG. 2a, a stage apparatus which includes an electromagnetic coupling between a reaction frame and a ground surface will be described in accordance with an embodiment of the present invention. A portion of a stage apparatus 202 includes a reaction frame 206, an air bearing 210, a reaction frame base 214, and a base 218. Reaction frame 206 effectively supports a portion of a linear motor (not shown) which serves to cause motion of a wafer stage (not shown) along an x-axis 204a, as will be discussed below with respect to FIGS. 2c and 2d. In one embodiment, reaction frame 206 may move slightly or deflect in a longitudinal direction along either x-axis 204a or a y-axis 204b, and rotate slightly with respect to a z-axis 204c. Such movement may be in response to longitudinal movement of the wafer stage (not shown) with respect to x-axis 204a or y-axis 204, or rotational movement of the wafer stage with respect to z-axis 204c.

A coupling to ground 222 is substantially coupled to reaction frame 206 through the use of an electromagnetic coupling 224. In one embodiment, electromagnetic coupling 224 may be coupled to reaction frame 206 through the use of a flexure assembly (not shown). While electromagnetic coupling 224 may generally be substantially any suitable electromagnetic device, in the described embodiment, electromagnetic coupling 224 is a voice coil motor (VCM). Other suitable electromagnetic devices or actuators may include, but are not limited to, linear motors and EI-core actuators.

As shown, electromagnetic coupling 224 includes a magnet 230 and a coil 232. Typically, movement of magnet 230 and coil 232 may occur with respect to three degrees of freedom, i.e., longitudinal movement may occur with respect to x-axis 204a or y-axis 204b while rotational movement may occur with respect to z-axis 204c. Electromagnetic coupling 224 provides stiffness and damping such that vibrations that may be transmitted through reaction frame 206 may be reduced. When current is provided to electromagnetic coupling 224, magnet 230 and coil 232 may cooperate to provide stiffness and damping between reaction frame 206 and connection to ground 222. Hence, ground vibrations which may otherwise be transmitted through connection to ground 222 to reaction frame 206 may be substantially isolated using electromagnetic coupling.

A position sensor 234 may be coupled to reaction frame 206 and electromagnetic coupling 224 to facilitate a determination of parameters associated with electromagnetic coupling 224. That is, position sensor 234 may sense a position associated with reaction frame 206 to determine how much relative movement there is between magnet 230 and coil 232 of electromagnetic coupling 224, and provide a reading that may be used to dynamically set the parameters associated with electromagnetic coupling 224. Generally, position sensor 234 may be substantially any linear encoder or capacitance sensor which enables the displacement of components of electromagnetic coupling 224 to be measured. In one embodiment, rather than measuring the displacement between magnet 230 and coil 232, position sensor 234 may measure the displacement of reaction frame 206 relative to magnet 230. As reaction frame 206 is coupled to coil 232, the displacement of reaction frame 206 relative to magnet 230 or connection to ground 222 may be substantially linearly proportional to the displacement of coil 232 relative to magnet 230.

In order for position sensor 234 to effectively provide a reading or information to electromagnetic coupling 224, both electromagnetic coupling 224 and position sensor 234 may be in communication with a computing device. FIG. 2b is a diagrammatic representation of stage apparatus 202 with a computing device which controls parameters associated with an electromagnetic coupling in accordance with an embodiment of the present invention. As shown, electromagnetic coupling 224 of FIG. 2a, which includes a magnet 230 and a coil 232, is represented as electromagnetic coupling 224′, which includes a spring 252 and a damper 254, that is in communication with a computing device 250. Spring 252 represents a stiffness ‘k’ associated with electromagnetic coupling 224′, while damper 254 represents a damping coefficient ‘c’ associated with electromagnetic coupling 224′.

Position sensor 234 provides information to computing device 250 which may be used by computing device 250 to adaptively adjust stiffness ‘k’ and damping coefficient ‘c’. Stiffness ‘k’ and damping coefficient ‘c’ may be adjusted to substantially prevent reaction frame 206 from moving, e.g., vibrating. That is, when position sensor 234 senses that displacement with respect to x-axis 204a has occurred, whether the translation is due to induced vibrations within reaction frame 206 or ground vibrations transmitted to reaction frame 206 by connection to ground 222, position sensor 234 provides information relating to an amount of translation to computing device 250. Computing device 250, which generally includes memory and a processor which executes computer program code associated with the operation of position sensor 234 and electromagnetic coupling 224′, determines how to adjust or alter stiffness ‘k’ and damping coefficient ‘c’ to substantially minimize the displacement within electromagnetic coupling 224. Computing device 250 may adjust the amount of current provided to electromagnetic coupling 224′ in order to adjust stiffness ‘k’ and damping coefficient ‘c’. By way of example, if the current is proportional to the position read by position sensor 234, electromagnetic coupling 224′ is effectively acting as a spring where the proportionality constant is substantially equivalent to stiffness ‘k’, then adjusting the proportionality constant using computing device 250 may be essentially equivalent to adjusting stiffness ‘k’. Alternatively, if the current is proportional to the velocity determined using position sensor 234 or read using a velocity sensor (not shown), then electromagnetic coupling 224′ is effectively acting as a damper where the proportionality constant is substantially equivalent to damping coefficient ‘c’, and adjusting the proportionality constant using computing device 250 may be essentially equivalent to adjusting damping coefficient ‘c’.

In general, computing device 250, electromagnetic coupling 224′, and position sensor 234 form a control system for damping out vibrations that are associated with reaction frame 206. Such a control system enables the amount of compensation for damping out or otherwise reducing vibrations associated with reaction frame 206 to be adaptively adjusted. In one embodiment, the control system acts as a low pass filter which prevents high frequency vibrations, e.g., vibrations of more than approximately a 10 Hertz (Hz) frequency, from being transmitted through electromagnetic coupling 224′.

As previously discussed, reaction frame 206 is arranged to support a linear motor which allows a wafer stage to be scanned along x-axis 204a and reaction forces to be created along x-axis 204a. With reference to FIGS. 2c and 2d, the function of such a linear motor with respect to an overall stage apparatus will be described. FIG. 2c is a diagrammatic top-view representation of a portion of a stage apparatus, i.e., stage apparatus 202 of FIG. 2a, while FIG. 2d is a diagrammatic cross-sectional representation of a portion of the stage apparatus, in accordance with an embodiment of the present invention. For ease of illustration, components of a stage apparatus 202′ including, but not limited to, a wafer stage base and various actuators, have not been shown. In addition, while overall stage apparatus 202′ generally includes components arranged to enable a wafer to be translated longitudinally along x-axis 204a and y-axis 204b, and to rotate with respect to z-axis 204c, substantially only components associated with longitudinal translation along x-axis 204a have been shown.

Stage apparatus 202′ includes reaction frame 206, air bearing 210, reaction frame base 214, and base 218, as discussed above. A stator 302, supported by reaction frame 206, and a coil 304 form a linear motor which allows a wafer table 320, which is coupled to coil 304 through a coupling arrangement 310, to move longitudinally along x-axis 204a. Stator 302 may be a linear array of permanent magnets which effectively form a track in which coil 304 may slide or otherwise move. It should be appreciated that the linear motor which includes stator 302 and coil 304 is one embodiment of a driver or driving mechanism which is suitable for causing motion of wafer table 320.

Coupling arrangement 310 generally includes components which enable the linear motor associated with stator 302 and coil 304 to move wafer table 320. For example, coupling arrangement 310 may include an actuator such as an EI-core motor, and a coupling which allows wafer table 320 to move along x-axis 204a. Wafer table 320, which is arranged to support a wafer that is being scanned, is generally arranged over a wafer stage base (not shown) which is separate from reaction frame base 214, and positioned substantially atop base 218.

A flexible coupling arrangement 306a, which may include any number of flexible couplings, substantially couples reaction frame 206 to ground surface 222 through electromagnetic coupling 224″. Flexible coupling arrangement 306a enables some relative motion between reaction frame 206 and electromagnetic coupling 224″. Reaction forces which are created when coil 304 moves along x-axis 204a are substantially absorbed by reaction frame 206. The reaction forces and subsequent vibrations which may be induced are effectively passed to ground surface 222 through electromagnetic coupling 224″.

When the magnitude of reaction forces or vibrations, e.g., vibrations associated with a servo loop associated with the linear motor which includes stator 302 and coil 304 or ground vibrations, varies, the stiffness and dampening associated with electromagnetic coupling 224″ may be altered automatically to compensate for the changed magnitude. Altering the stiffness and dampening associated with electromagnetic coupling 224″ to compensate for changes in the magnitude of reaction forces or vibrations enables the effect of the reaction forces or vibrations on stage apparatus 202′ to be substantially minimized.

As will be appreciated by those skilled in the art, a wafer stage may also be arranged to be scanned along y-axis 204b. That is, a wafer stage is generally arranged to operate in more than one translational degree of freedom and, hence, may include a reaction frame or frames which function to absorb reaction forces associated with the various translational degrees of freedom. Typically, overall stage apparatus 202′ may include multiple reaction frames. For example, overall stage apparatus 202′ may include components which reduce vibrations transmitted through a reaction frame (not shown) that is associated with a linear motor (not shown) which enables a wafer to be translated along y-axis 204b.

Alternatively, reaction frame 206 may be coupled to components which enable any reaction forces associated with translation of a wafer along y-axis 204b to be absorbed into ground surface 222 through reaction frame 206. Such components may include, but are not limited to, flexible coupling arrangements 306b-c and electromagnetic couplings 324a-b. An arrangement of reaction frames and flexible couplings within a stage apparatus such as overall stage apparatus 202′ will be described below with respect to FIG. 3.

FIG. 3 is a diagrammatic top-view representation of a portion of a scanning apparatus which includes multiple electromagnetic connections to ground in accordance with an embodiment of the present invention. A scanning apparatus 352 generally includes a stage that is arranged to support a wafer, and components which enable the stage to translate along an x-axis 354a and a y-axis 354b, and to rotate with respect to a z-axis 354c. However, such components have not been shown for ease of illustration.

Scanning apparatus 352 includes electromagnetic couplings 360 which are arranged to isolate vibrations. Electromagnetic couplings 360 are coupled to a support 370 that is coupled to a grounding surface. In the described embodiment, electromagnetic couplings 360 are VCMs, although it should be appreciated that electromagnetic couplings 360 may be substantially any suitable electromagnetic actuator, as described above. Electromagnetic couplings 360 are coupled through linkage rods 364 to reaction frames 368. Each reaction frame 368 is generally arranged to support a linear motor which translates along x-axis 354a. As shown, reaction frame 368b supports a linear motor 372 which is arranged to be coupled to a wafer stage (not shown) that moves over an air bearing base 374. Reaction frames 368 are each separated from a reaction frame base (not shown), e.g., reaction frame base 214 of FIGS. 2c-d, by an air bearing (not shown). Linkage rods 382 separate reaction frames 368 along y-axis 354b, and have flexure couplings 381 to enable a substantially parallel geometry to be maintained between reaction frames 368.

Electromagnetic couplings 380 are arranged to couple reaction frames 368 to support 370 along y-axis 354b. Electromagnetic couplings 380 are arranged to impart reaction forces associated with movement of a wafer stage (not shown) along y-axis 354b to a grounding surface through support 370, and to isolate vibrations associated with support 370. It should be appreciated that electromagnetic couplings 380 may also reduce vibrations that are induced within reaction frames 368.

As mentioned above, electromagnetic couplings which have controllable stiffness and damping parameters may be used to damp or absorb vibrations, e.g., relatively high frequency vibrations. The selection of values for the parameters for a given electromagnetic coupling may be achieved through the use of information associated with the positioning of components within the electromagnetic coupling, or a position associated with a reaction frame to which the electromagnetic coupling is substantially attached. With reference to FIG. 4, a control algorithm which may be used to control a displacement of one component of an electromagnetic coupling relative to another component will be described in accordance with an embodiment of the present invention. A control system 402 includes a plant 405 which is to be controlled. In the described embodiment, plant 405 may be a reaction frame that is substantially coupled to a component. Controlling plant 405, in such an embodiment, may include maintaining a desired gap between reaction frame 206 and ground of FIG. 2d such that the position of reaction frame 206 of FIG. 2d is as desired.

An input 409 into control system 402 may be a desired gap, e.g., a desired gap between reaction frame 206 and ground of FIG. 2d. The actual gap between reaction frame 206 and ground may be determined using information provided from a sensor that effectively measures a position of reaction frame 206, e.g., position sensor 234 of FIG. 2a. The size of the actual gap, which is an output 413 of plant 405, may be compared to input 409. That is, a difference 417 between output 413 and input 409 may be determined, and difference 417 may be augmented by a variable stiffness 421 that varies as needed in an attempt to achieve a desired output 413. In the described embodiment, stiffness 421 is controlled by software, and is effectively automatically varied. Augmenting difference 417 by stiffness 421 effectively generates a force 425 which may be provided to plant 405.

Another input 429 into control system 402 may be a desired velocity such as a velocity of reaction frame 206 of FIG. 2d. As will be appreciated by those skilled in the art, a desired velocity may be a substantially zero velocity. Typically, input 409 and input 429 may be provided by software, e.g., a computer program which is effective to execute to implement control system 402. Output 413 of plant 405 is differentiated using a differentiator 431. That is, the actual gap as measured by a position sensor, which is effectively a distance, is differentiated using differentiator 431 to create a corresponding velocity 433. Velocity 433 is compared against input 429, and a resultant difference 435 between velocity 433 and input 429 is augmented by a damping coefficient 439 to obtain a corresponding force 441. Force 441, like force 425, may be provided to plant 405 to control plant 405. Damping coefficient 439 may be varied using software such that a desired amount of damping, or damping that is sufficient to cooperate with a stiffness to cause a measured gap and a measured velocity to reach a desired gap and a desired velocity, respectively. That is, like stiffness 421, damping coefficient 439 is effectively adaptive and may be adjusted to obtain a desired output 413.

In general, control system 402 is arranged to control plant 405 such that a desired gap and a desired velocity, e.g., a substantially zero gap and a substantially zero velocity, are obtained. When difference 417 and difference 429 each have a value of approximately zero, then plant 405 is essentially controlled such that relatively high frequency vibrations and reaction forces do not affect a reaction frame. Since control system 402 is adaptive, control parameters such as stiffness 421 and a damping coefficient 421 may be adjusted such that the level of stiffness and damping associated with an electromagnetic coupling is appropriate to compensate for varying amounts of ground vibrations or induced vibrations.

With reference to FIG. 5, a photolithography apparatus which includes a reaction frame with an electromagnetic connection to ground will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator. The planar motor which drives wafer positioning stage 52 generally uses an electromagnetic force generated by magnets and corresponding armature coils arranged in two dimensions. A wafer 64 is held in place on a wafer holder 74 which is coupled to wafer table 51. Wafer positioning stage 52 is arranged to move in multiple degrees of freedom, e.g., between three to six degrees of freedom, under the control of a control unit 60 and a system controller 62. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In the described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. As described above, reaction forces may be released to the floor or ground through a VCM or voice coil motor (not shown) that is substantially in contact with reaction frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, and is arranged to project a radiant energy, e.g., light, through a mask pattern on a reticle 68 that is supported by and scanned using a reticle stage which includes a coarse stage and a fine stage. The radiant energy is focused through projection optical system 46, which is supported on a projection optics frame 50 and may be released to the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. Such information may be used to facilitate the control of a VCM or a linear motor 80 which effectively couples wafer positioning stage 52 to ground while reducing transmitted vibrations. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head. Further, an adjustable force damper may also be applied to a proximity photolithography system that exposes a mask pattern by closely locating a mask and a substrate without the use of a lens assembly. Additionally, an adjustable force damper may be used in other devices including, but not limited to, other semiconductor processing equipment, machine tools, metal cutting machines, and inspection machines.

The illumination source of illumination system 42 may be g-line (436 nanometers (nm)), i-line (365 nm), a KrF excimer laser (248 nm), a ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultraviolet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. As described above, wafer positioning stage 52 may release forces to the floor or ground through a VCM or voice coil motor (not shown) that substantially couples reaction frame 66 to the ground. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

As described above, a photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

Further, semiconductor devices may be fabricated using systems described above, as will be discussed with reference to FIG. 6. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 7. In step 1305, the semiconductor device is assembled. The assembly of the semiconductor device generally includes, but is not limited to, wafer dicing processes, bonding processes, and packaging processes. Finally, the completed device is inspected in step 1306.

FIG. 7 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, a position sensor which senses displacement associated with an electromagnetic coupling has been described as being suitable for use in providing information to a computing system to enable parameters associated with the electromagnetic coupling to reduce the displacement. It should be appreciated, however, that in lieu of a position sensor, substantially any sensor which provides information relating to motion within the electromagnetic coupling or motion of a reaction frame may be implemented for use.

A photolithography apparatus or exposure apparatus has been described as including four electromagnetic couplings between reaction frames and ground. As discussed above with respect to FIG. 3, two electromagnetic couplings are described as being aligned along an x-axis and two electromagnetic couplings are described as being aligned along a y-axis. That is, a plurality of electromagnetic couplings has been described as being used to reduce vibrations associated with a reaction frame which supports a linear motor which causes motion of a stage in an x-direction, and a plurality of electromagnetic couplings has been described as being used to reduce vibrations associated with a reaction frame which supports a linear motor which causes motion of a stage in a y-directions. In general, any number of electromagnetic couplings may be used with respect to a stage scanning apparatus. For instance, in an embodiment in which adaptive control of stiffness and dampening along one axis is not needed, a less complicated shock absorber may be used with respect to the reaction frame associated with that axis, while electromagnetic couplings may be used along another axis. That is, a stage apparatus may use a combination of shock absorbers and electromagnetic couplings to compensate for vibrations.

Heat may be generated by electromagnetic couplings such as VCMs. In order to compensate for the heat generated by electromagnetic couplings, e.g., to prevent the heat from affecting the operation of an apparatus which uses the electromagnetic couplings, cooling measures may be adopted for use with the apparatus. While such measures may vary, such measures often include providing liquid cooling to the electromagnetic couplings.

A reaction frame which has electromagnetic connections to ground has been described as being suitable for use with respect to a wafer scanning stage of an apparatus. It should be understood that a reaction frame which has electromagnetic connections to ground may generally be used with respect to substantially any apparatus or portion of an apparatus in which vibrations are undesirable. For example, a reaction frame which has electromagnetic connections to ground may be used with, or slightly modified to be used with, a reticle scanning stage. Therefore, the present examples are to be considered as illustrative and not restrictive, and the invention is not to be limited to the details given herein, but may be modified within the scope of the appended claims.

What is claimed is:

1. A scanning stage apparatus comprising:
a stage base;
a stage, the stage being arranged to move over the stage base, wherein the stage is arranged to move in a first translational direction, a second translational direction, and a first rotational direction;
a driver, the driver being arranged to cause the stage to move, the driver further being arranged to cause at least one reaction force to be created when the stage moves;
a reaction frame, the reaction frame being arranged to at least partially support the driver, the reaction frame and the driver being substantially decoupled from the stage base, wherein the at least one reaction force is arranged to be transmitted to the reaction frame; and
an electromagnetic coupling, the electromagnetic coupling being arranged to electromagnetically couple the reaction frame to a ground, wherein the electromagnetic coupling is arranged to provide a stiffness and a damping between the reaction frame and the ground.

2. The scanning stage apparatus of claim 1 wherein the stiffness and the damping are adjustable.

3. The scanning stage apparatus of claim 2 wherein the stiffness and the damping are automatically adjustable, further including:
a sensor, the sensor being arranged to determine a measurement associated with the reaction frame, the sensor being coupled to the electromagnetic coupling, wherein the measurement is arranged to be used to automatically adjust the stiffness and the damping.

4. The scanning stage apparatus of claim 2 wherein the stiffness and the damping are adjusted to reduce vibrations which are transmitted from the ground to the reaction frame.

5. The scanning stage apparatus of claim 2 wherein the stiffness and the damping are adjusted to reduce vibrations which are induced within the reaction frame.

6. The scanning stage apparatus of claim 1 wherein the electromagnetic coupling is one of an electromagnetic actuator, a linear motor, an EI core motor, and a voice coil motor.

7. The scanning stage apparatus of claim 1 wherein the at least one reaction force includes a reaction force in the first translational direction, and the electromagnetic coupling is arranged to couple the reaction force to the ground along the first translational direction.

8. An exposure apparatus comprising the scanning apparatus of claim 1.

9. A device manufactured with the exposure apparatus of claim 8.

10. A wafer on which an image has been formed by the exposure apparatus of claim 8.

11. A stage assembly comprising:
a stage base;
a stage, the stage being arranged to slide with respect to the stage base, wherein the stage has three associated degrees of freedom;
a motor, the motor being arranged to cause the stage to slide with respect to at least one of the three associated degrees of freedom, wherein when the motor causes the stage to slide with respect to the at least one of the three associated degrees of freedom, and at least one reaction force is created with respect to the at least one of the three associated degrees of freedom;
a frame, the frame being arranged to support at least a portion of the motor, the frame being substantially mechanically decoupled from the stage base to substantially prevent the at least one reaction force from affecting the stage, wherein the at least one reaction force is arranged to be imparted on the frame; and
an actuator, the actuator being arranged to be coupled between the reaction frame and a ground surface, the actuator having a stiffness and a damping, the actuator further being arranged to reduce a transmission of vibrations through the reaction frame.

12. The stage assembly of claim 11 wherein the stiffness and the damping are adjustable.

13. The stage assembly of claim 12 further including a control system, the control system being arranged to adjust the stiffness and the damping to compensate for changes in the vibrations.

14. The stage assembly of claim 13 wherein the control system is arranged to adjust the stiffness and the damping to control a parameter associated with the actuator, the parameter being one of a distance and a velocity associated with the actuator.

15. The stage assembly of claim 10 wherein the actuator is arranged to reduce vibrations induced within the reaction frame.

16. The stage assembly of claim 10 wherein the actuator is arranged to reduce vibrations transmitted to the reaction frame from the ground surface.

17. The stage assembly of claim 10 wherein the actuator is one of an electromagnetic actuator, a linear motor, an EI-core motor, and a voice coil motor.

18. An exposure apparatus comprising the stage assembly of claim 11.

19. A device manufactured with the exposure apparatus of claim 18.

20. A wafer on which an image has been formed by the exposure apparatus of claim 18.

21. A stage assembly comprising:
a stage base;
a stage, the stage being arranged to slide with respect to the stage base, wherein the stage has three associated degrees of freedom;
a motor, the motor being arranged to cause the stage to slide with respect to at least one of the three associated degrees of freedom, wherein when the motor causes the stage to slide with respect to the at least one of the three associated degrees of freedom, a at least one reaction force is created;
a frame, the frame being arranged to support at least a portion of the motor, the frame being substantially mechanically decoupled from the stage base to substantially prevent the at least one reaction force from affecting the stage, wherein the at least one reaction force is arranged to be imparted on the frame; and
a low-pass filter, the low-pass filter being arranged between the reaction frame and a ground surface, the low-pass filter being arranged to filter vibrations transmitted between the ground surface and the reaction frame through the low-pass filter.

22. The stage assembly of claim 21 wherein the low-pass filter is arranged to filter vibrations of a frequency that is higher than approximately ten Hertz.

23. The stage assembly of claim 21 wherein the low-pass filter has an associated damping and an associated stiffness, the associated damping and the associated stiffness being variable to compensate for changes in vibrations transmitted between through the low-pass filter.

24. The stage assembly of claim 23 wherein the low-pass filter is an electromagnetic actuator.

25. An exposure apparatus comprising the stage assembly of claim 21.

26. A device manufactured with the exposure apparatus of claim 25.

27. A wafer on which an image has been formed by the exposure apparatus of claim 25.

28. A frame structure, the frame structure being suitable for use in a scanning apparatus, the frame structure comprising:
a body, the body being arranged to support a driving mechanism that is arranged to drive a stage, wherein the body is further arranged to substantially absorb a reaction force generated by the driving mechanism when the driving mechanism drives the stage; and
an electromagnetic actuator, the electromagnetic actuator having a stiffness and a damping, the electromagnetic actuator being coupled to the body, wherein the electromagnetic actuator is arranged to couple the body to a ground surface to reduce the affects of vibrations induced within the body.
